(19) United States
(12) Patent Application Publication
(10) Pub. No.: US 2009/0169351 A1
(43) Pub. Date: Jul. 2, 2009

(54) AUTOMATIC STACKING DEVICE

(76) Inventor: Kuan-Shiung Wu, Yangmei Township (TW)

Correspondence Address: LEONG C LEI, PMB # 1008, 1867 YGNACIO VALLEY ROAD, WALNUT CREEK, CA, 94598, US

(21) Appl. No.: 12/019,649

(22) Filed: Jan. 25, 2008

(30) Foreign Application Priority Data
Dec. 26, 2007 (TW) 096222124

(51) Int. Cl. B65G 57/02

(52) U.S. Cl. 414/791.2

(57) ABSTRACT

An automatic stacking device includes a plurality of successive conveyors to convey properly cut corrugated paper board. By setting the conveyors at different operation speeds and different levels, paper boards can be deposited in stacked forms by predetermined numbers. Thus, the paper boards are deposited to form alternately offset stacks in a vertical pile of paper board. Mechanisms are incorporated to laterally shifted stacks of paper boards during the deposition of the paper boards to allow the paper boards to be piled up in the form of multiple and alternately shifted stacks to facilitate subsequent packaging and shipping.

### BACKGROUND OF THE INVENTION

(a) Technical Field of the Invention

The present invention relates to an automatic stacking device for corrugated paper board, and in particular to a paper board stacking device that is capable to deposit paper boards in respective and separate stacks.

(b) Description of the Prior Art

Currently, corrugated paper boards are made by first shaping a corrugated core to which surface boards are adhered. The corrugated paper boards so made are then subjected to cutting and slitting to have a desired size. Then, the cut paper boards are manually collected and packaged.

Since the cut paper boards are collected and packaged manually, a lot of human effort and time are needed in packaging so that the packaging costs are very high.

### SUMMARY OF TUE INVENTION

The primary purpose of the present invention is to an automatic stacking device, which comprises a plurality of successively arranged conveyors for conveying cut paper boards and any flat paper products. By setting a difference in level between first and second conveyors, a first stack of paper boards can be separated from a second stacks and the paper boards can be stacked in an alternately stacked manner by predetermined numbers for transportation. It is also possible to pile a subsequent stack of paper boards on a preceding stack of paper boards and mechanisms are employed to alternately shift the paper board stacks in puling piling up the stacks to facilitate subsequent packaging and shipping. Further, the present invention also features setting of a fixed number of paper boards to be stacked or setting the number of paper boards in each stack and no manual counting is needed.

The present invention further provides a stacking platform that is carried by a conveyor for transporting stacked paper boards to the next working station to carry out other processing, such as packaging, and this allows saving of human labor and speeding up of packaging operation to enhance throughput.

Further, front and rear barriers are provided on the stacking platform to facilitate stacking of paper boards. A slidable carrier is used to move the front barrier back and forth to adjust the distance between the front and rear barriers to accommodate various sizes of paper boards. The barriers are selectively elevated to control the position of the paper stacks. Further, the stacking platform is coupled to a moving mechanism. The moving mechanism is operated in cooperation with the front and rear barriers to slightly shift newly deposited paper board with respect to the previously stacked paper boards once the previously stacked paper boards reaches a predetermined quantity in order to facilitate packaging or counting.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a side elevational view of an automatic stacking device constructed in accordance with the present invention;

FIGS. 2A-2E are side elevational views demonstrating the operation of the automatic stacking device in stacking paper boards; and

FIG. 3A-3F illustrating the stacking operation of paper boards carried out by the stacking device of the present invention.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

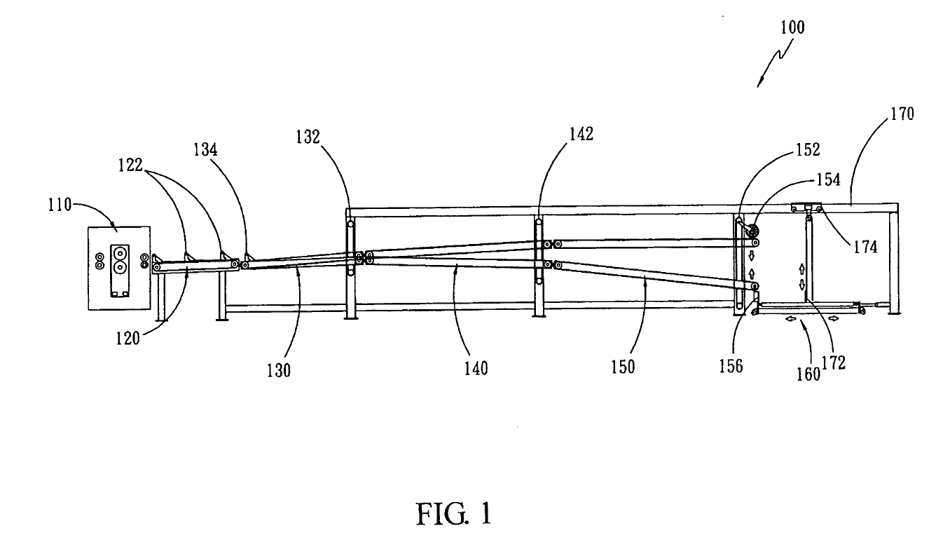

With reference to the drawings, and in particular to FIG. 1, the present invention provides an automatic stacking device, which is generally designated at 100, for conveying and stacking cut/slit corrugated paper board. The automatic stacking device 100 is arranged to connect to a rear discharge end of a paper board cutting machine 110 to receive cut corrugated paper board or other cut paper boards of any desired form or shape. The automatic stacking device 100 comprises a first conveyor 120, a second conveyor 130, an intermediate conveyor 140, a rear conveyor 150, at least one hold-down bar 122, which can be alternatively in the form of a hold-down roller, at least one second hold-down bar 134, which can also be alternatively in the form of a hold-down roller, a first elevator mechanism 132, a second elevator mechanism 142, a third elevator mechanism 152, and a stacking platform 160. The first conveyor 120 has a front end closely adjacent to the cutting machine 110 to receive the corrugate paper boards fed out of the cutting machine 110. The first hold-down bar 122 is arranged above the first conveyor 120 to hold down the corrugated paper boards conveyed through the first conveyor 120. The second conveyor 130 has a front end that is coupled to a rear end of the first conveyor 120 by a connection mechanism, such as a universal joint or a key and keyway set. The connection mechanism can be any known means and no further detail will given hereinafter, and it is noted that any variation or equivalents thereof is considered belonging to the scope of the present invention. Further, the rear end of the first conveyor 120 is set at a level that is higher than the front end of the second conveyor 130 so that during the operation of the device, paper boards can be smoothly and successively transferred to the second conveyor 130 and the paper boards can be successively deposited and stacked on the second conveyor 130. The intermediate conveyor 140 is coupled to a rear end of the second conveyor 130, preferably by a connection mechanism, and the rear conveyor 150 is coupled to a rear end of the intermediate conveyor 140, preferably by a connection mechanism, whereby by regulating the operation speeds of the conveyors, quantity based deposition/stacking of paper boards can be realized. The first elevator mechanism 132 is coupled to the second conveyor 130 to selectively elevate/lower the rear end of the second conveyor 130 in a controlled manner. The second elevator mechanism 142 is coupled to the intermediate conveyor 140; and the third elevator mechanism 152 is coupled to the rear conveyor 150 for selectively elevating/lowering a rear end of the rear conveyor 150. By employing the elevator mechanisms to adjust the levels of the second conveyor, the intermediate conveyor, and the rear conveyor 150 and by controlling the operation speeds of the conveyors and/or the control of spacing distance, the paper boards can be deposited/stacked in a desired manner. It is noted that the first to third elevator mechanisms can be any device/mechanism or equivalents thereof that are effective in selectively moving the conveyors up and down in a controlled manner.

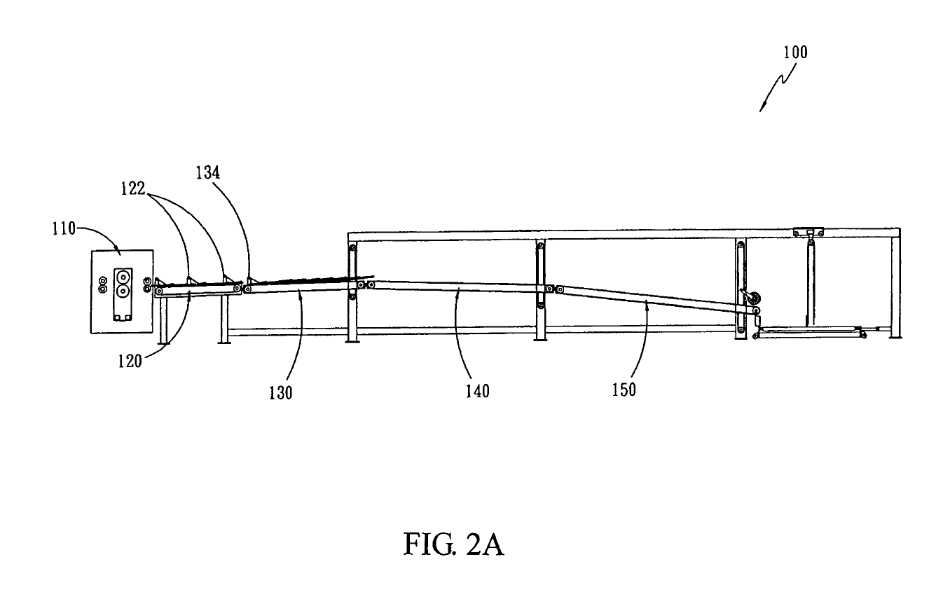

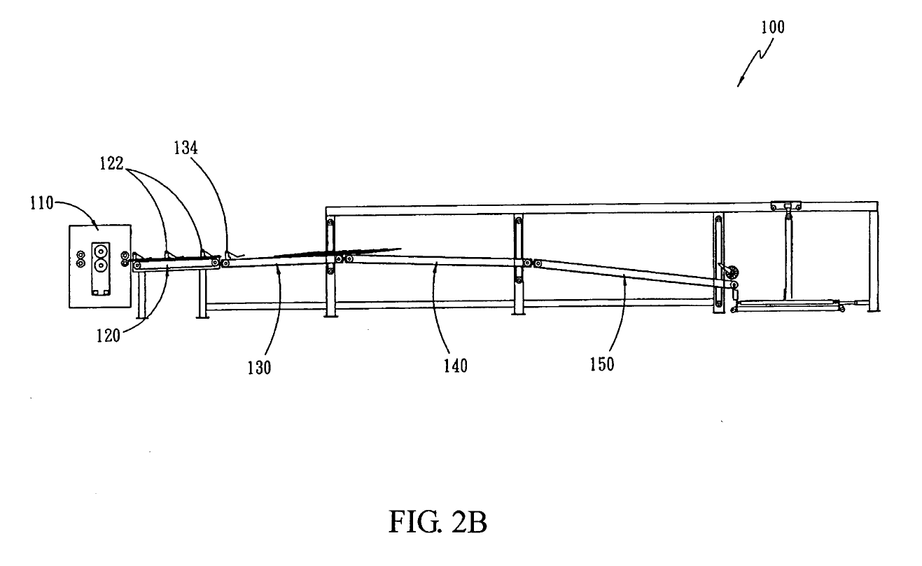

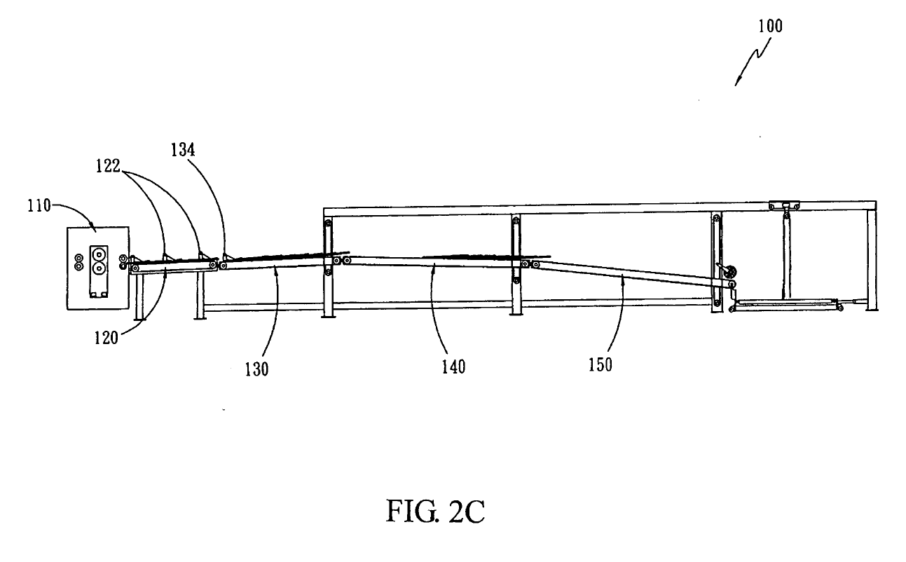

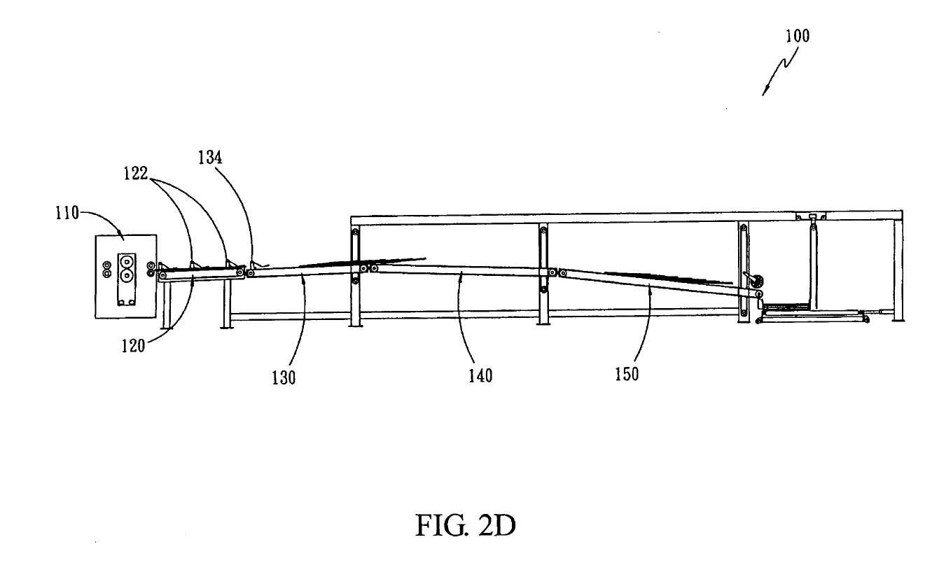

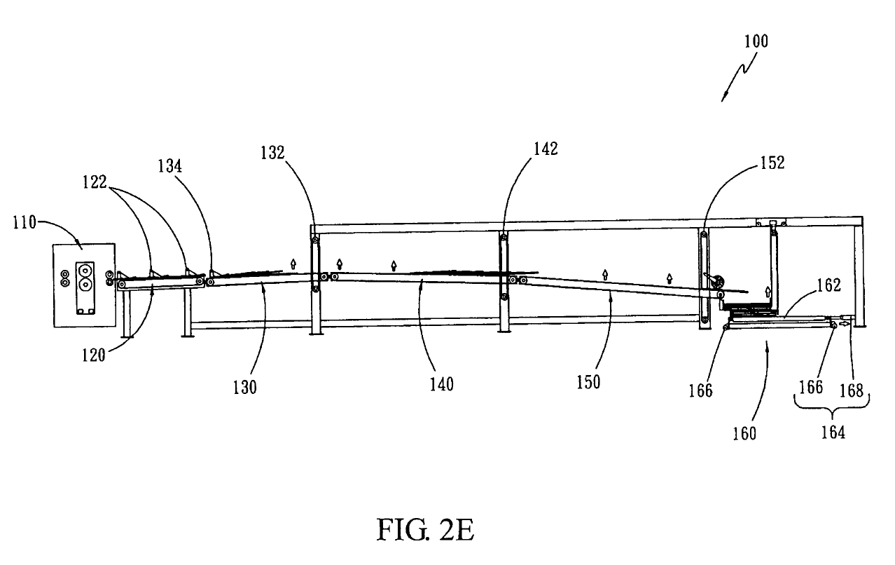

Referring to FIGS. 2A-2E, an example of the operation of the device in accordance with the preset invention will be given. The operation speed of the first conveyor 120 is set faster than the second conveyor 130. Since the rear end of the first conveyor 120 is higher than the front end of the second conveyor 130, the movement of the paper boards will be that the paper boards on the second conveyor 130 are moved slower than those on the first conveyor 120. Thus, when a paper board slides from the first conveyor 120 down onto the second conveyor 130, a portion of the paper board overlaps a preceding paper board to form partial stacking deposition on the second conveyor 130. When a predetermined number of paper boards is reached, the operation speeds of the second conveyor 130, the intermediate conveyor 140, and the rear conveyor 150 are switched to be faster than that of the first conveyor 120 to transport the deposited paper boards rearwards and at the same time, the first conveyor 120 is set to a lower operation speed. Once the stack of the previously deposited paper boards exits the second conveyor 140, the first conveyor 120 is switched back to the fast operation speed to convey off the paper boards on the first conveyor 20, while the second conveyor 140 is again set in the low operation speed to allow subsequent deposition of the paper boards thereon. In the meantime, the intermediate conveyor 140 and the rear conveyor 150 can be set at a fast speed or maintained at the original speed to rearward convey the paper boards. The sequence of speed regulation is then repeated to cyclically set the operation speeds of the conveyors to eventually realize stacking of the paper boards in a batch basis. It is apparent that the present invention is not limited to the above discussed sequence of speed regulation or adjustment for the conveyors and can be of various ways of speed regulation or adjustment. Any feasible or effective manner of regulating or adjusting operation speeds of the conveyors that may realized batch-based stacking of paper boards is considered well within the scope of the present invention provided that the device defined in the attached claims is employed to realize the stacking.

Referring to FIGS. 1 and 2A-2E, the stacking platform 160 is arranged behind the rear end of the rear conveyor 150 at a location lower than the rear end so that when the paper boards that are conveyed by the rear conveyor 150 reaches the rear end thereof falls to the stacking platform 160, the paper boards will be automatically and successively stacked on the stacking platform 160 in order. Thus, the present invention may realize stacking of paper boards by controlling the operation speeds of the conveyors and elevation adjustments of the elevator mechanisms so that the present invention is advantageous in increasing throughput in a given period of time.

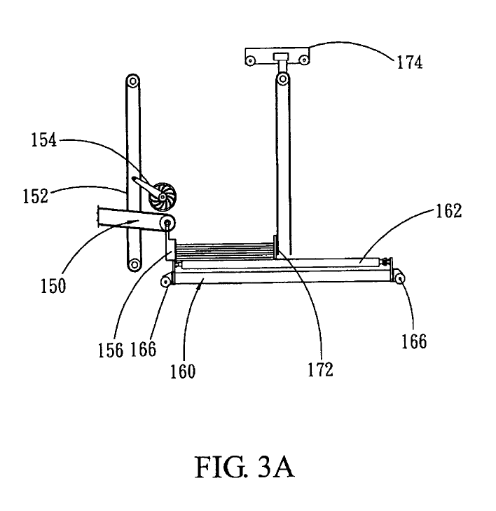

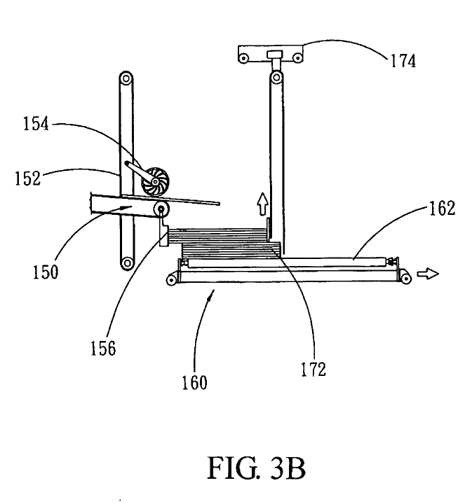

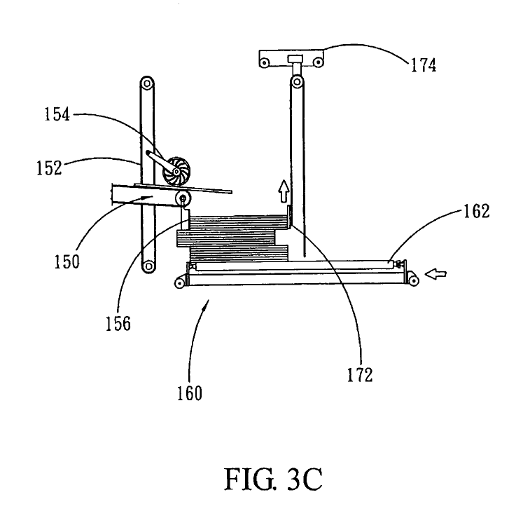

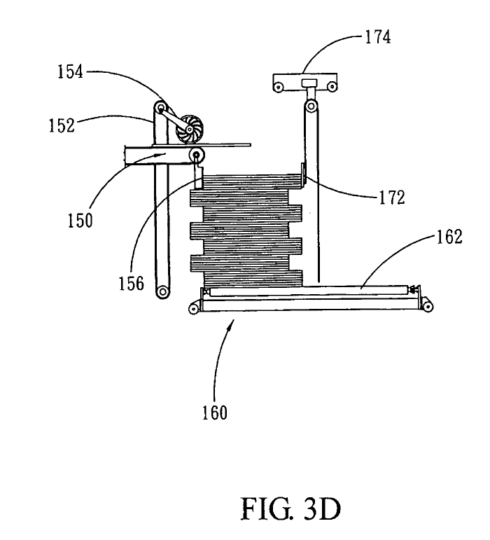

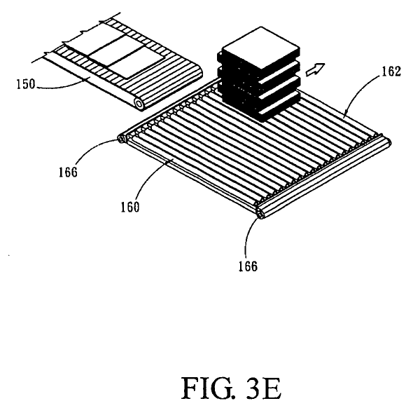

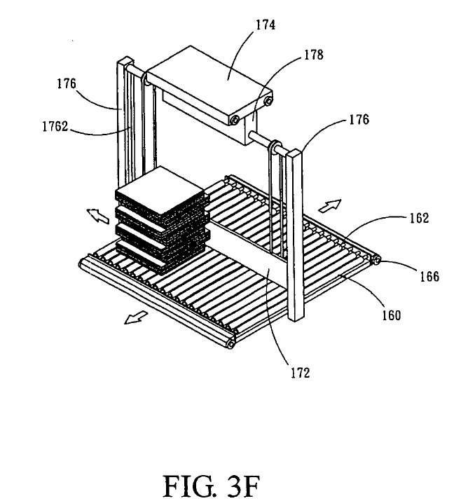

Also referring to FIGS. 3A and 3F, the stacking platform 160 is coupled to a conveyor 162 so that after the paper boards are completely stacked on the stacking platform 160, they can be transported to a next work station by the conveyor 162. Further, a front barrier 172 and a rear barrier 156, both being preferably in the form of a flat board, can be additionally provided to facilitate orderly stacking of the paper boards when they falls onto the stacking platform 160. The rear conveyor 150 is provided at the rear end thereof with a hold-down roller 154, which depresses the paper boards down to increase the friction between the paper boards and the rear conveyor 150 in order to ensure smooth movement of the paper boards.

As shown in FIGS. 2E and 3F, the rear barrier 156 is pivoted to the rear conveyor 150 and the rear barrier 156 is vertically movable with the elevation/lowering of the rear end of the rear conveyor 150. Further, the stacking platform 160 is further provided with a moving mechanism 164, which comprises a plurality of rollers 166 arranged below the stacking platform 160 and at least one driving unit 168. The driving unit 168 controls reciprocal movement of the stacking platform 160 in a given direction. The driving unit 168 can be for example a pneumatic cylinder or a hydraulic cylinder or a motor, but not limited thereto. A front barrier support frame 170 (see FIG. 1), a front barrier slide 174, a front barrier elevating device 178, and two front barrier rails 176 are arranged above the stacking platform 160. The front barrier support frame 170 comprises a frame-like structure on which the slide 174 is arranged to be reciprocally slidable with respect to the support frame 170. The elevating device 178 is mounted to the slide 174 and is coupled to the front barrier 172 so that when the slide 174 changes relative position thereof with respect to the support frame 170, the front barrier 172 moves in unison with the slide 174 to set at a desired location thereby changing the distance between the front barrier 172 and the rear barrier 156 to accommodate difference in size of the paper boards. In addition, the rails 176 are arranged outboard the opposite edges of the front barrier 172 and are connected to the slide 174. Further, the rails 176 form in opposing surfaces thereof channels 1762 that receives the opposite edges of the Front barrier 172 so that the elevating device 178 may drive the front barrier 172 to vertically move along the channels 1762 to thereby realize elevation/lowering of the front barrier 172 (in the vertical direction). It is noted that the elevating device 178 is of a generally known driving mechanism, such as a motor set, and further detail is not needed herein. When the paper boards has been stacked to a desired level or reaches a given quantity, the moving mechanism 164 drives the stacking platform 160 to move forward or rearward and at the same time, the rear barrier 156 and the front barrier 172 simultaneously and vertically moved to a desired level to make the space under the barriers 172, 156 unblocked and free for avoiding collision with the paper board stacked below and for depositing a new stack of paper boards on the previous stack in an slightly offsetting or shifted manner to ease pick-up and packing in a batch manner and thereby facilitating shipping. Further, in accordance with the change of the elevation of the rear end of the rear conveyor 150 by the third elevator mechanism 152, the first and second elevator mechanisms 132, 142 are operated to make changes to the elevation thereof in order to maintain smooth and orderly conveyance of the paper boards by the conveyors.

If desired, a counter (not shown) can be arranged on the first conveyor 120 for counting the number of the paper boards moving through the first conveyor in order to provide a parameter for facilitating control and setting of the operation speeds of the conveyors. The counter can be of any known structure or can be any known sensor.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A paper board stacking device, which is adapted to arranged behind a rear discharge end of a paper cutting machine to convey the cut paper boards, the paper board stacking device comprising:
a first conveyor having a front end adjacent to the rear discharge end of the paper cutting machine for receiving the cut paper boards;
a second conveyor having a front end coupled to a rear end of the first conveyor, the rear end of the first conveyor being set at a level higher than the front end of the second conveyor;
a first elevator mechanism coupled to the second conveyor for selectively and vertically moving a rear end of the second conveyor;
an intermediate conveyor having a front end coupled to the rear end of the second conveyor;
a second elevator mechanism coupled to the intermediate conveyor for selectively and vertically moving a rear end of the intermediate conveyor;
a rear conveyor having a front end coupled to the rear end of the intermediate conveyor;
a third elevator mechanism coupled to the rear conveyor for selectively and vertically moving a rear end of the rear conveyor; and
a stacking platform arranged behind the rear end of the rear conveyor at a location below the rear end of the rear conveyor for receiving and stacking paper boards conveyed through the rear conveyor;
wherein by controlling operation speeds of the conveyors and adjusting vertical locations of the second conveyor the intermediate conveyor, and the rear conveyor, stacking of the paper board is carried out during the conveyance of the paper boards.

2. The paper board stacking device as claimed in claim 1, wherein connection means is provided between the first conveyor and the second conveyor, the second conveyor and the intermediate conveyor, and the intermediate conveyor and the rear conveyor for respectively coupling the conveyors.

3. The paper board stacking device as claimed in claim 2, wherein the connection means comprises a universal joint.

4. The paper board stacking device as claimed in claim 3 further comprising a counter located above the first conveyor and at least one hold-down member arranged adjacent the rear end of the rear conveyor.

5. The paper board stacking device as claimed in claim 4, wherein the stacking platform is coupled to a conveyor and the paper board stacking device further comprises:
a support frame,
a slide mounted on the support frame and slidable with respect to the support frame,
an elevating device mounted on the slide,
two spaced rails arranged on opposite sides of the slide and each forming a channel,
a front barrier comprising a board coupled to the elevating device and having opposite edges movably received in the channels of the rails so that the front barrier is selectively movable along the rails by the elevating device, and
a rear barrier spaced from the front barrier and comprising a board pivotally coupled to the rear conveyor,
wherein by the movement of the slide with respect to the support frame to change relative position therebetween, the front barrier and the rails are moved to change a distance between the front and rear barriers.

6. The paper board stacking device as claimed in claim 5, wherein the stacking platform comprises a moving mechanism, which comprises rollers arranged below the stacking platform and at least one driving unit.

7. The paper board stacking device as claimed in claim 6, wherein the driving unit comprises a pneumatic or hydraulic cylinder or a motor.

8. The paper board stacking device as claimed in claim 7, wherein the first conveyor comprises a first hold-down bar for holding down paper boards conveyed therethrough, and wherein the second conveyor comprises a second hold-down bar for holding down paper boards conveyed therethrough.
